(19) United States
(12) Patent Application Publication
(10) Pub. No.: US 2026/0281252 A1
(43) Pub. Date: Sep. 17, 2026

(54) CONVERGED CHARGING FOR USER EQUIPMENTS OF PUBLIC NETWORK AND NON-PUBLIC NETWORK

(71) Applicant: Telefonaktiebolaget LM Ericsson (publ), Stockholm (SE)

(72) Inventors: Settipalli NARASIMHAM, Chennai (IN); Arvindh Rajesh TAMILMANI, Chennai (IN); Karthikeyan CHANDRASEKAR, Chennai (IN)

(73) Assignee: Telefonaktiebolaget LM Ericsson (publ), Stockholm (SE)

(21) Appl. No.: 19/472,180

(22) PCT Filed: Apr. 3, 2023
(86) PCT No.: PCT/IN2023/050323

§ 371 Date: Oct. 3, 2025

(51) Int. Cl. H04M 15/00; H04W 4/24; H04W 88/06

(52) U.S. Cl. CPC H04M 15/61; H04M 15/80; H04M 15/8228; H04W 4/24; H04W 88/06

(57) ABSTRACT

Embodiments of the present disclosure provide a method for charging of a user equipment, UE belonging to at least one of a public network, PN, and a non-public network, NPN, for network delivered services is provided. The public network integrated non-public network, PNI-NPN, is implemented in a wireless network communication network, the method being performed by a network charging function in the PNI-NPN of the wireless communication network. The method comprises identifying whether the UE belongs to the PN or the NPN and determining a network rating function for the UE based on the identification of the UE. When the UE belongs to the PN, the network rating function is defined for a plurality of UEs belonging to the PN and when the UE belongs to the NPN, one or more network rating functions are defined for a plurality of UEs belonging to the NPNs.

### TECHNICAL FIELD

The present disclosure generally relates to the field of charging systems. More particularly, it relates to a method, converged charging system and computer program products for charging of a user equipment, UE, belonging to a public network, PN, and/or a non-public network, NPN, for network delivered services.

### BACKGROUND

Generally, Communication Service Providers, CSPs, all over the globe offer wide variety of services to a plurality of customers, by leveraging advantage of modern cellular systems, for example, 5G New Radio, NR, systems. A public land mobile network, PLMN, is a public network established and operated for the public to provide land mobile communication services. With the development of 5G network services, non-public network, NPN, has also emerged. NPN is a private network established separately for some groups of people. Telecom regulators are granting 5G licenses for traditional PLMN operators and also to private networks. The private networks are a kind of hybrid networks in a 5G core network.

The NPN enables deployment of 5G network for private use. The NPN may be deployed as a Stand-alone Non-Public Network, SNPN, operated by an NPN operator, or a public network integrated NPN, PNI-NPN i.e., a non-public network deployed with the support of a PLMN. The third generation partnership project, 3GPP, specifies the ability for a user equipment, UE, to obtain PLMN services while camping on the SNPN when the UE has a subscription to obtain services from both PLMN and SNPN. In the case of PNI-NPN, PLMN ID identifies the network.

In the 5G networks, mobile country code, MCC, and mobile network code, MNC, and PLMN ID are used to uniquely identify the network. In order to identify a subscriber, subscription permanent identifier, SUPI and mobile station international subscriber directory number, MS-ISDN are primarily used. When the NPN is deployed as public network integrated NPN, PNI-NPN, i.e., when the private network is integrated into PLMN network or to a 5G core network, new parameters such as PNI NPN is defined and a network service identifier is used.

The 3rd Generation Partnership Project, 3GPP, standard group has defined a set of specifications about online charging systems and offline charging systems to cover charging in the various network domains (i.e., a circuit switching network domain, a packet switching network domain, or a wireless domain), IP multimedia subsystems, and emerging 3G application services.

In the 5G systems, the integration of private networks into public networks is still evolving and the identification of private networks is to be performed in order to initiate charging functionality to be performed on the private networks. In the present 3GPP specification, two different subscribers are considered as two different entities for UE and NPN charging, i.e., two types of subscribers are considered in the context of NPN i.e., NPN service customer, NPN-SC, and the individual end-user “UE” served under the NPN.

### SUMMARY

In order to initiate charging functionality on the private networks for the services of the private network, it is important to identify the private networks.

With seamless integration of 5G private networks, identifying network specific identifiers in charging data request, CDR, helps in recording UE visiting network details and also the UE identifiers. The charging functionality and tariff details can be accorded based on the network usage and charging rules for the private networks. Indicating private network parameters such as a public network identifier of non-public network, PNI NPN, and the network information where UE is connected to 5G network, i.e., on boarding network, provides information about UE's cell selection and it's parameters in the CDR. With the process of on-boarding the UE gains access to the wired or wireless network for the first time and therefore, it is important to identify the PNI NPN, and network information where UE is connected to 5G network.

It is therefore an object of the present disclosure to provide a method, a converged charging system and computer program product that seeks to mitigate, alleviate, or eliminate all or at least some of the above-discussed drawbacks of presently known solutions.

This and other objects are achieved by means of a method, a computer program product, and a device as defined in the appended claims. The term exemplary is in the present context to be understood as serving as an instance, example or illustration.

According to a first aspect of the present disclosure, a method for charging of a user equipment, UE belonging to at least one of a public network, PN, and a non-public network, NPN, for network delivered services is provided. The public network integrated non-public network, PNI-NPN, is implemented in a wireless network communication network, the method being performed by a network charging function in the PNI-NPN of the wireless communication network. The network charging function is configured for charging the UE for the network delivered services. The method comprises identifying whether the UE belongs to the PN or the NPN and determining a network rating function for the UE based on the identification of the UE. When the UE belongs to the PN, the network rating function is defined for a plurality of UEs belonging to the PN and when the UE belongs to the NPN, one or more network rating functions are defined for a plurality of UEs belonging to the NPNs. The proposed method allows charging of the UEs belonging to public network and/or private network. The one or more network rating function are defined for the UEs belonging to the private networks, thereby to charge the UEs belonging to the private networks.

Thus, when the UEs which are on-boarded or connected to the networks through PNI NPN are allowed to use 5G services after authentication and authorization, the on-boarding network, network service identifier and PNI NPN information are recorded in a charging data request. Therefore, network parameters such as on-boarding network, network service identifier and PNI NPN are exchanged between session management function, SMF to common access function through charging data request message to initiate charging of the UE.

In some embodiments, the step of initiating charging of the UE according to the determined network rating function for the UE comprises obtaining information related to a network delivered service being requested by the UE and determining a network rating function suitable for rendering the network delivered service for the UE. Further, the method comprises receiving, from a session management function, a charging data request, the charging data request comprising network related parameters of the UE and initiating charging of the UE for the network delivered service rendered to the UE according to the determined rating function using the network related parameters. Therefore, with the proposed method, the network related parameters provide authentication, authorization and accounting, AAA functionality with more security and also for charging of the UEs. The charging functions can be activated based on agreements with private network into 5G RAN and 5G core network.

In some embodiments, the step of identifying whether the UE belongs to a PN or a NPN comprises receiving, from a session management function, SMF, network related parameters of the UE and identifying whether the UE belongs to a PN or a NPN based on the network related parameters. The proposed method allows identification of UEs i.e., whether the UEs belong to the public network or the private network is identified for charging the UEs.

In some embodiments, network related parameters comprise one or more of a mobile country code, MCC, a mobile station international subscriber directory number, a public network identifier of NPN, a default credential server, DCS, and a network service identifier. The network related parameters are recorded in charging data request, CDR, and these network related parameters are sent from the SMF to the common access function which helps identifying NPNs for performing charging based on On-boarded PNI NPN network. The proposed method allows identification of network specific identifiers which helps in recording UE visiting network details and also the UE identifiers. The charging functionality and tariff details can be accorded based on the network usage and charging rules for the private networks.

In some embodiments, the step of receiving from a session management function, SMF, network related parameters of the UE comprises receiving a charging data request, CDR, from the SMF, wherein the CDR comprises the network related parameters of the UE. The SMF transmits the charging data request through Nchf to a common access function. It should be noted that when the UE belongs to the NPN, the charging data request comprises public network identifier of NPN, DCS and network service identifier, to the common access function 220. With the proposed method, the private network identifiers are recorded in the CDR and these network identifiers are transmitted from the SMF to the charging function which also helps identifying the private networks and then for performing charging of the UEs.

In some embodiments, the step of initiating charging of the UE for the network delivered service rendered to the UE according to the determined rating function using the network related parameters comprises storing the network related parameters received in the CDR and receiving a charging service request. The method comprises transmitting a charging service response and initiating the charging of the UE. The proposed method can be used for charging the UEs belonging to the public network and/or the private network according to the determined rating function using the network related parameters.

According to a second aspect of the present disclosure, a charging system for charging a user equipment, UE, belonging to at least one of a public network, PN, and a non-public network, NPN, for network delivered services is provided. A public network integrated non-public network, PNI-NPN, is implemented in a wireless communication network. The charging system comprises a common access function, a network rating function belonging to the PN and one or more network rating functions belonging to the NPN and a network charging function. The charging system being configured to identify whether the UE belongs to the PN or the NPN and to determine a network rating function for the UE based on the identification of the UE. When the UE belongs to the PN, the network rating function is defined for a plurality of UEs belonging to the PN and when the UE belongs to the NPN, one or more network rating functions are defined for a plurality of UEs belonging to the NPNs. The charging system being configured to initiate charging of the UE according to the determined network rating function for the UE.

The proposed converged charging system provides flexibility to handle single common access for handling charging functionality for multiple private networks. The network charging function can be configured in high availability mode such that charging functionality is uninterrupted. The common access function facilitates failover handing when one access charging function fails and the SMF can identify inaccessible access function and routes the charging traffic to other available cluster or node to another access function.

According to a third aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1A and 1B discloses an example of an industrial environment;

FIG. 2 is an example converged charging system for charging of user equipment, UE belonging to a public network and/or private network;

FIG. 3A is a flowchart illustrating example method steps for charging of the UE belonging to the public network and/or private network;

FIG. 3B is a flowchart illustrating example method steps for initiating charging of the UE according to a determined network rating function for the UE;

FIG. 4 is an example block diagram showing network functions involved in authentication and authorization of a user equipment;

FIG. 5 is an example block diagram showing communication among various core network functions through interfaces;

FIGS. 6A-6F are example sequence diagrams illustrating transmission of network identifiers in a charging data request to a charging function, according to some embodiments;

FIG. 7 is an example block diagram showing various interface among the network functions involved in charging of user equipment belonging to public network and/or non-public networks;

FIG. 8 is an example sequence diagram showing various signalling messages exchanged for charging of the UE belonging to public network and/or private network;

FIG. 9 is an example bock diagram illustrating multiple non-public networks connected to a common access function and a network charging function; and

FIG. 10 discloses an example computing environment.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the following description of exemplary embodiments, the same reference numerals denote the same or similar components.

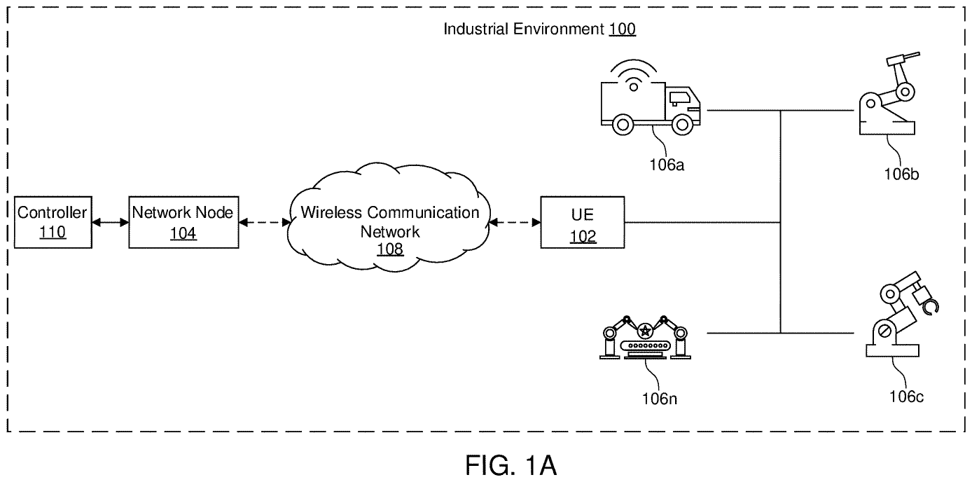

In general, industrial and smart factories with 5G license as private network can be operated. All internet of Things, IoT, devices or 3GPP UE's or Non-3GPP UE which can be configured as 3GPP UE, standalone private networks can be offered. These private networks collaborate with 5G Telecom operators and provide all the 5G services that include data, voice, IoT messaging and streaming services. In an example scenario, FIG. 1A discloses an industrial environment 100. Some of the examples of the industry environment 100 may include a factory, a manufacturing unit, guided robotic environment, or the like. The industrial environment 100 comprises a network node 104, a user equipment, UE, 102, and a plurality of industrial devices 106a, 106b, 106c and so on to 106n. The network node 104 communicates with the UE 102 through a wireless communication network 108 for controlling the plurality of industrial devices 106a-106n. For example, the UE 102 is configured to receive data packets from the network node 104 through the wireless communication network 108. For example, the network node 104 may be a radio access network comprising a plurality of base stations or evolved node base stations (not shown) or the internet using one or more suitable communication protocols for transmitting the data packets to the UE 102. The industrial environment 100 may further comprise a controller 110 configured to generate control messages according to an input from a user. Examples of the industrial devices 106 a-106n may include a 6DOF robotic arm, collaborating robotic arms, Automated Guided Vehicles, AGVs, with omni-wheels, or other robotic devices.

The network node 104 is configured to acquire one or more control messages intended to control the industrial devices 106a-106n from the controller 110. The control messages may comprise a set of commands intended for the industrial devices 106a-106n. For example, each industrial device 106a-106n comprises one or more actuators (e.g. servos, arms or the like, not shown in FIG. 1) for performing assigned tasks. The set of commands may be defined by an application installed in the network node 104 or may be acquired from an external controller 110. The set of commands instruct the industrial devices 106a-106n how to perform the task. For example, the set of commands comprise a trajectory path to be followed by the industrial device 106a-106n. Further, the network node 104 transmits the control messages to the UE 102 through the wireless communication network 108. The UE 102 is configured to receive the control messages from the network node 104. The UE 102 further transmits the received control messages to the industrial devices 106a-106n. The industrial devices 106a-106n perform the allocated tasks according to the control messages. It should be noted that the industrial environment 100 is not limited to above-mentioned components, other components can also be present in the industrial environment 100 other than the component shown in the FIG. 1A.

In some examples, the network node 104 and/or the UE 102 may be a wireless device that is stationary or mobile and may also be referred to as a remote station, a mobile station, an application, a user equipment, a mobile equipment, a terminal, a remote terminal, an access terminal, a station, etc. The wireless device may be a cellular phone, a personal digital assistant (PDA), a wireless modem, a wireless communication device, a handheld device, a subscriber unit, a laptop computer, etc.

In an example implementation, the industrial devices 106a-106n are connected with a single UE 102, as illustrated in FIG. 1A. In another implementation, each industrial device 106a-106n is equipped with a UE (102a-102n), as illustrated in FIG. 1B.

In the 5G systems, the integration of private networks i.e., non-public networks, NPNs into public networks is still evolving and the identification of private networks is to be performed in order to initiate charging functionality on the private networks. In the present 3GPP specification, two different subscribers are considered as two different entities for the UE and NPN charging, i.e., two types of subscribers are considered in the context of NPN i.e., NPN service customer, NPN-SC, and an individual end-user “UE” served under the NPN.

In order to initiate charging functionality to be performed on the private networks for the services of the private network, it is important to identify the private networks.

Therefore, according to the embodiments of the present disclosure, a method for charging of a user equipment, UE belonging to at least one of a public network, PN, and a non-public network, NPN, for network delivered services is provided. The public network integrated non-public network, PNI-NPN, is implemented in a wireless network communication network. The method is performed by a network charging function in the PNI-NPN of the wireless communication network. The method comprises identifying whether the UE belongs to the PN or the NPN and determining a network rating function for the UE based on the identification of the UE. When the UE belongs to the PN, the UE rating function is defined for a plurality of UEs belonging to the PN and when the UE belongs to the NPN, one or more NPN rating functions are defined for a plurality of UEs belonging to the NPNs.

Thus, with the seamless integration of 5G private networks, identifying network specific identifiers, for example, in charging data request, CDR, helps in recording UE visiting network details and the UE identifiers. The charging functionality and tariff details can be accorded based on the network usage and charging rules for the private networks. Indicating private network parameters such as PNI NPN, on-boarding network where UE's are connected to 5G network provides more details about UE's cell selection and it's parameters in the CDR.

Various embodiments for charging a UE belonging to a public network and/or non-public network are disclosed in conjunction with figures in the later parts of the description.

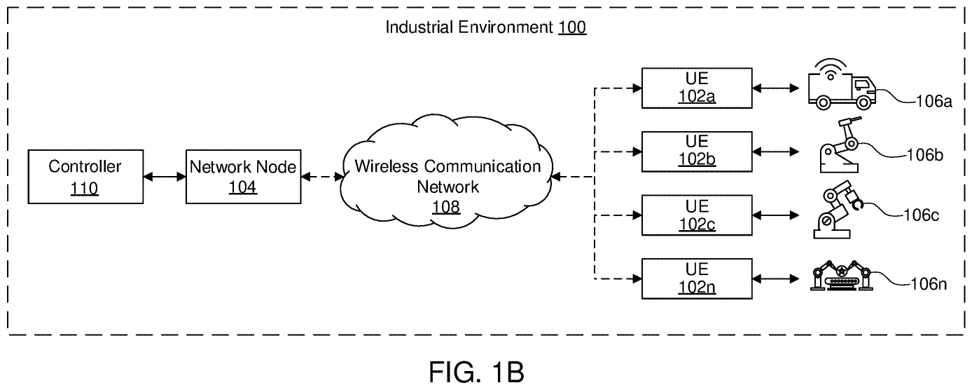

FIG. 2 is an example converged charging system 200 for charging of user equipments, UEs, belonging to public network and/or private networks. The converged charging system 200 can be deployed in the network node 104 as depicted in the FIGS. 1A and 1B.

As depicted in the FIG. 2, the converged charging system 200 comprises a common access function 220, a UE rating function 240a, a NPN rating function 240b and a NPN rating function 240c. There can be any number of the NPN rating functions 240-240n defined for each NPN. The common access function 220 is connected to different rating network functions i.e., the UE rating function 240a, the NPN rating function 240b and the NPN rating function 240c. Further, the UE rating function 240a, the NPN rating function 240b and the NPN rating function 240c are converged to a network charging function 260.

It should be noted that one or more PNI NPN networks can be connected to common access function 220 which is connected to multiple rating network functions that can be either belonging to the public network or the NPN. The charging triggers can be dynamically provisioned in rating network functions 240a-240n and is indicated to SMF through common access function 220. The network charging function 260 is configured to initiate charging of the UE according to the determined rating function. For example, if the UE is identified to be a PN UE, then the network charging function 260 is configured to initiate charging of the UE according to the UE rating function 240a using the network related parameters of the UE. Thus, the network charging function 260 is configured to communicate with the rating functions i.e., either the UE rating function 240a, or NPN rating function 240b or NPN rating function 240c to initiate the charging of the UE. It should be noted that the network charging function 260 is configured to communicate with the UE rating function 240a and also the one or more NPN rating functions 240b and 240c as shown in the FIG. 2.

The network rating functions 240a-240c comprise any function, application, or system that performs non-monetary and/or monetary unit determination for voice and/or data services. The rating functions 240a-240c may provide the following functionalities: rating for network and external services and applications (session, service, or event) before and after service delivery, and cross-product and cross-channel discounts, benefits, and/or allowances. The rating functions 240a-240c are accessible directly or indirectly to the common access function 220 and the network charging function 260.

In an example, the network rating functions 240a-240c may represent a processing function in a network, which may have a functional behavior and/or interfaces. The network rating functions 240a-240c may be implemented either as a network element on a dedicated hardware, and/or a network node or as a software instance running on a dedicated hardware and/or shared hardware, or as a virtualized function instantiated on an appropriate platform.

The converged charging system 200 may be implemented in the network node but not limited to, a server (for example, a standalone server, or a server residing in a cloud). In some example implementations, the network node can be a server residing in a cloud environment. The proposed converged charging system 200 can be implemented in the cloud using one or more virtual machines.

The common access function 220 is configured to identify whether the UE belongs to the PN or the NPN by receiving from a session management function, SMF 270, network related parameters of the UE. The network related parameters may include mobile country code, MCC, mobile station international subscriber directory number, MSISDN, public network identifier of NPN, PNI NPN, default credential server, DCS and network service identifier. In some examples, the SMF 270 receives the network related parameters of the UE via AMF after authentication of the UE.

When the network related parameters are received are received from the SMF, the common access function 220 is configured to identify whether the UE belongs to the PN or a NPN based on the network related parameters. If the common access function 220 identifies that the UE belongs to the PN, then the common access function 220 determines the network rating function 240a which is a UE rating function. Further, if the common access function 220 identifies that the UE belongs to the NPN, then the common access function 220 determines the network rating functions i.e., 240b or 240b which are belonging to NPN rating functions.

In some examples, the UE rating function 240a can be configured to support RAT type trigger for the UE and the NPN rating functions 240b or 240c can be configured to support Location change triggers. Both the triggers are notified to common access function 220 which in turn enables those triggers and indicates to the SMF 270. When the SMF 270 detects the triggers, Charging Data requests, CDRs, are triggered from the SMF 270.

Therefore, the common access function 220 ensures all the UEs are tracked through command network charging function 260 and the rating functions 240a-240c are scaled with multiple network functions. Further, the common network charging function 260 is configured to serve multiple network rating functions.

When the SMF 270 requests for granted service units, GSU for PNI NPN enabled UEs, the common access function 220 sends request to one or more network rating functions 240a-240c. The rating functions 240a-240c verifies account balance and indicates the network charging function 260 and grants the service units. When one more than one GSU units received from different Rating units, common access function selects least common denominator GSU received for the PNI NPN network enabled devices. This is applicable for charging Data request i.e., initial request and also for the intermedia requests.

Thus, with the proposed converged charging system 200, the UE and NPN charging is performed for the same subscriber, thereby simplifying provisioning and balance management. The charging functionalities can be activated based on agreements with private network into 5G RAN and 5G core network. In addition, it is also required to identify the UE whether it is a normal 5G device or on-boarded through PNI NPN networks. These parameters are obtained through AAA functionality with more security and thereby to initiate the charging functionality.

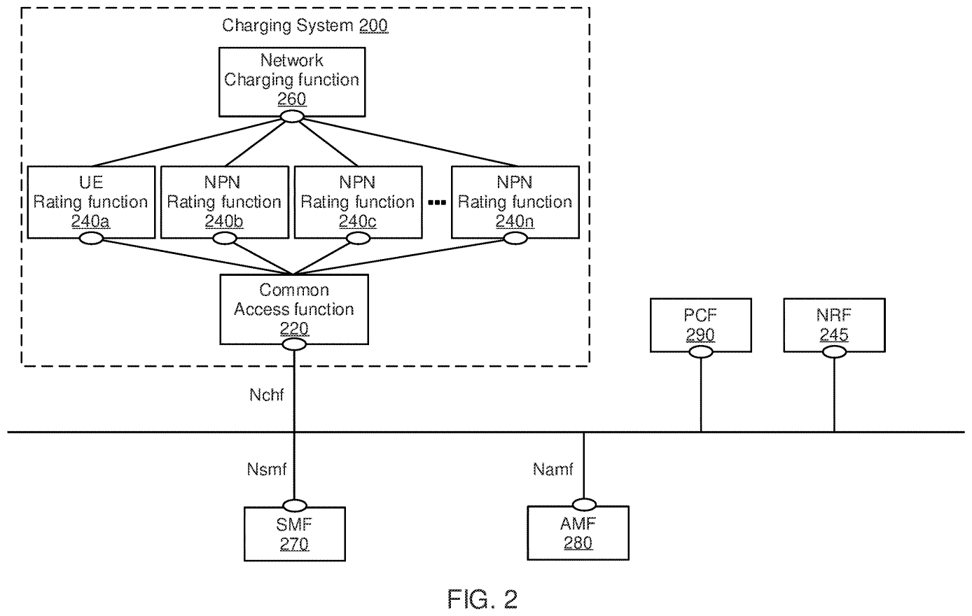

FIG. 3A is a flowchart illustrating example method 300 for charging of the UE belonging to the public network and/or private network. At step 302, the method 300 comprises identifying whether the UE belongs to a public network, PN or the NPN. The UE is identified whether it belongs to the PN or the NPN.

In an embodiment, the common access function is configured to receive the network related parameters of the UE from the SMF. The network related parameters may include mobile country code, MCC, mobile station international subscriber directory number, MSISDN, public network identifier of NPN, default credential server, DCS and network service identifier. The common access function identifies whether the UE belongs to the public network or the NPN based on the network related parameters.

At step 304, the method 300 comprises determining the network rating function for the UE based on the identification of the UE. The common access function is configured to determine the network rating function for the UE. In an example, if the common access function determines that the UE belongs to the public network, then the common access function determines the network rating function as the UE rating function. If the common access function determines that the UE belongs to the NPN, then the common access function determines a corresponding NPN rating function.

Thus, the common access function is configured to determine the rating function for the UE based on the identification of the UE.

It should be noted that when the UE belongs to the PN, the network rating function is defined for a plurality of UEs belonging to the PN and when the UE belongs to the NPN, one or more network rating functions are defined for a plurality of UEs belonging to the NPNs.

At step 306, the method 300 comprises initiating charging of the UE according to the determined network rating function for the UE. The network charging function is configured to initiate charging of the UE according to the determined rating function. For example, if the UE is identified to be PN UE, then the network charging function is configured to initiate charging of the UE according to the UE rating function using the network related parameters of the UE. The network charging function is configured to communicate with the rating functions i.e., either the UE rating function or NPN rating function or NPN rating function to initiate the charging of the UE.

FIG. 3B is a flow chart illustrating example method steps for initiating charging of the UE according to the determined network rating function for the UE. At step 306a, the method comprises obtaining information related to the network delivered service being requested by the UE. The common access function is configured to obtain information related to the network delivered service being requested by the UE.

At step 306b, the method comprises determining a network rating function suitable for rendering the network delivered service for the UE. The common access function is configured to determine the rating function i.e., either a UE rating function or a NPN rating function suitable for rendering the network delivered service for the UE.

At step 306c, the method comprises receiving from the SMF, a charging data request, the charging data request comprising network related parameters of the UE. The common access function is configured to receive from the SMF, a charging data request comprising network related parameters of the UE. Further, the common access function is configured to transmit the CDR comprising the network related parameters of the UE to the charging function 260.

At step 306d, the method comprises initiating charging of the UE for the network delivered service rendered to the UE according to the determined rating function using the network related parameters. When the charging function receives the CDR comprising the network related parameters of the UE, the charging function is configured to initiate the charging of the UE for the network delivered service rendered to the UE according to the determined rating function using the network related parameters.

In some embodiments, the charging function is configured to store the network related parameters received in the CDR. The charging function is configured to receive a charging service request from the common access function and further to transmit a charging service response to the common access function. The charging function is configured to initiate the charging of the UE using the network related parameters.

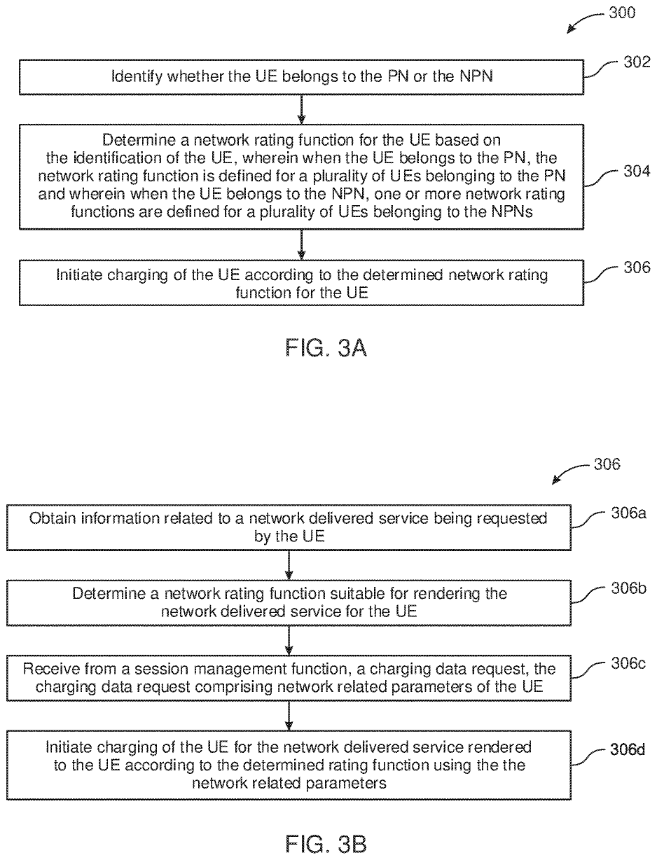

FIG. 4 is an example block diagram showing network functions involved in authentication and authorization of the UE. The UEs belonging to private network or NPN are identified and authenticated, for example based on the mechanisms specified on 3GPP TS 23.501 release V17.5.0. As depicted in the FIG. 4, the UEs belonging to the NPN are identified and thereafter authentication, authorization and accounting, AAA, is performed. The registration procedure is performed towards UE from 5G Core network may be indicated as “PNI NPN Onboarding UE's”. The authentication and authorization performed by onboarding AMF and AUSF.

As shown in the FIG. 4, authentication and authorization performed through DCS using PNI NPN AAA server through onboarded network AMF/AUSF through N83 interface. The authentication and authorization ensures security procedures are verified and allowed to use 3GPP access and core network.

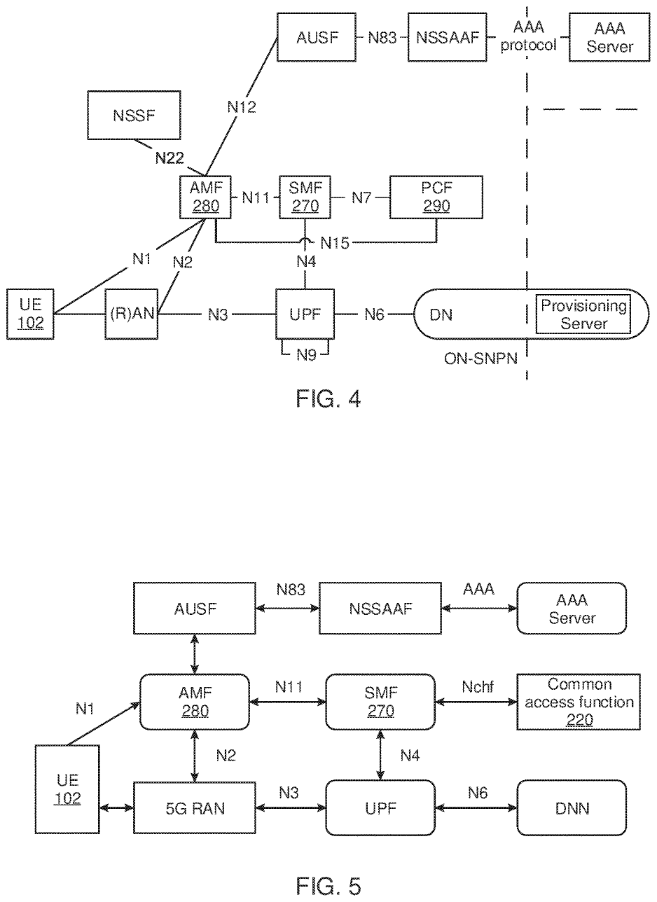

FIG. 5 is an example block diagram showing communication among various core network functions through interfaces. As depicted in the FIG. 5, the 5G private networks are integrated to RAN and Core network and private network parameters are accessed. The 3GPP release 17 allows integration or accessing 5G network for Non-public networks and configuring UE 102 with required parameters to identify the PNI NPN network is specified.

The PNI NPN and DCS parameters are sent from AMF 280 to SMF 270. The SMF 270 uses these parameters in charging event or session based functionalities for data, voice and for network slice specific events. When UE 102 is connected to 5G network, the UE 102 uses the 5G data services and there exists provisioning mechanism to recognize it as 3GPP UE 102.

The network identifiers such as PNI NPN, DCS and network service identifier are transmitted from AMF 280 to SMF 270 via standard SBI interface. When data or voice over NR activated for PNI NPN networks, in charging interface, these parameters are transmitted from the SMF 270 to the common access function 220 and then to record the PNI NPN, DCS and network service identifier in CDR.

In some examples, in JSON Body, the network parameters are transmitted from the SMF 270 to common access function 220 in initial, intermediate and terminate messages. It should be noted that these network identifiers can be used for both event and session based charging.

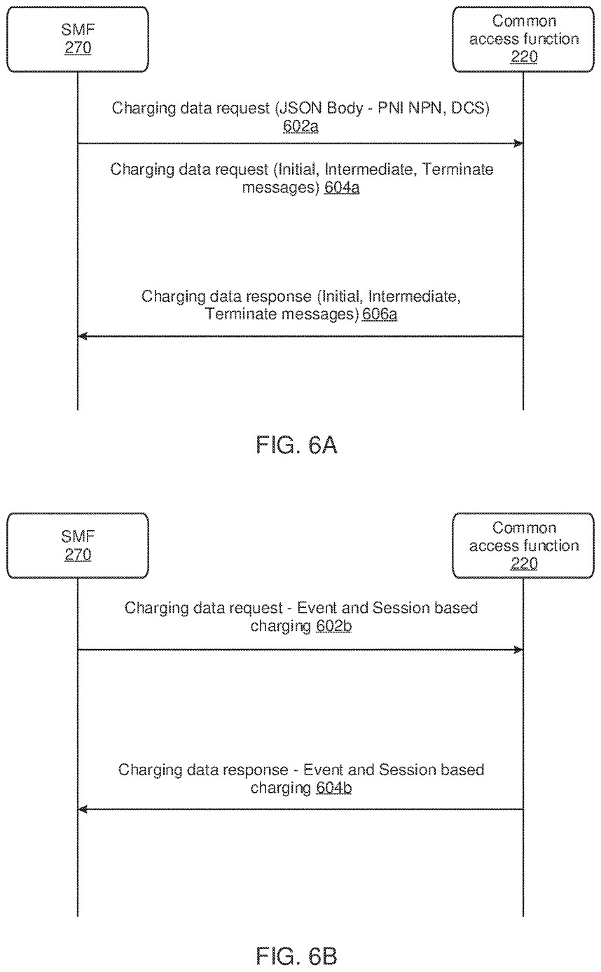

FIGS. 6A-6F are example sequence diagrams illustrating transmission of network identifiers in a charging data request to a charging function, according to some embodiments.

As depicted in the FIG. 6A, the SMF 270 transmits 602a a charging data request comprising PNI NPN and DCS in JSON body to the common access function 220. In JSON Body, these network identifiers are sent from SMF 270 to common access function 220 in CHF Charging initial, intermediate and terminate messages. Further, the SMF 270 receives a charging data response from the common access function 220.

These network identifiers can be used for both event and session based charging as depicted in the FIG. 6B in which the SMF 270 transmits 602b charging data request to the common access function 220 for event and session based charging and further receives charging data response from the common access function 220.

In some examples, the SMF 270 transmits 602c HTTP POST request message comprising charging data to the common access function 220 as depicted in the FIG. 6C. At successful operation, the common access function 220 transmits 604c, “201 created” response to the SMF. On failure operation, “4xx, 5xx or 3xx” shall be returned to the SMF 270.

In some examples, for an update procedure from SMF 270 to common access function 220 for a private network UE, the network identifiers are exchanged in JSON Body. The SMF 270 transmits 602d HTTP POST request message comprising charging data update to the common access function 220 as depicted in the FIG. 6D. At successful operation, the common access function 220 transmits 604d, “200 OK” response to the SMF 270. On failure operation, “4xx, 5xx or 3xx” shall be returned to the SMF 270.

In some examples, when the charging request are terminated or final GSU indications to be reported, then the private network identifiers can be exchanged. The SMF 270 transmits 602e HTTP POST request message comprising charging data reference to the common access function 220 as depicted in the FIG. 6E. At successful operation, the common access function 220 transmits 604e, “204 No Content” response to the SMF 270. On failure operation, “4xx, 5xx or 3xx” shall be returned to the SMF 270.

In some examples, during reauthorization of a PNI NPN UE 102, the private network identifiers can be exchanged. Reauthorization shall be triggered from common access function 220 to authorize the PNI NPN UE 102 and to validate the credentials of the UE 102. The common access function 220 transmits 602e HTTP POST Notify URI request message comprising charging data reference to the SMF as depicted in the FIG. 6F. At successful operation, the SMF 270 transmits 604f, “204 No Content” response to common access function 220. On failure operation, “4xx, 5xx or 3xx” shall be returned to the common access function 220.

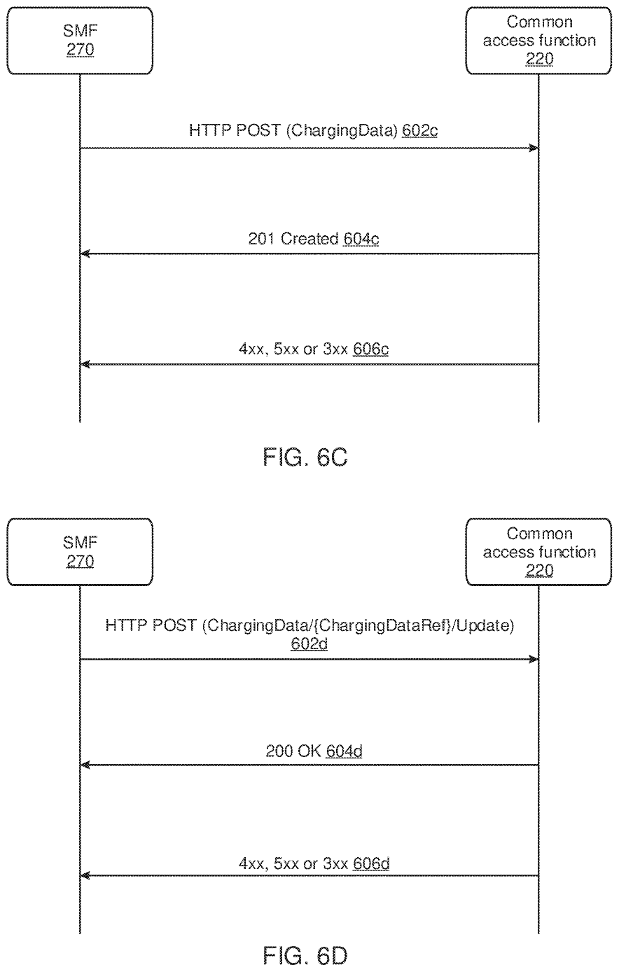

FIG. 7 is an example block diagram showing various interfaces among the network functions involved in charging of user equipment belonging to public network and/or non-public networks. As depicted in the FIG. 7, the converged charging system comprises a common access function 220, a UE rating function 240a, a NPN rating function 240b and a NPN rating function 240c. There can be any number of the NPN rating functions 240-240n defined for each NPN. The common access function 220 is connected to different rating network functions.

The above converged charging system enables distributed charging functionality across multiple rating functions from common core network access and increases the capacity of the system and enables much more scalability issues when multiple NPN networks connected to 5G RAN.

The proposed converged charging system provides flexibility to handle single common access for handling charging functionality for multiple private networks. The network charging function 260 can be configured in high availability mode such that charging functionality is uninterrupted. The common access function 220 facilitates failover handing when one access charging function fails and the SMF 270 can identify inaccessible access function and routes the charging traffic to other available cluster or node to another access function.

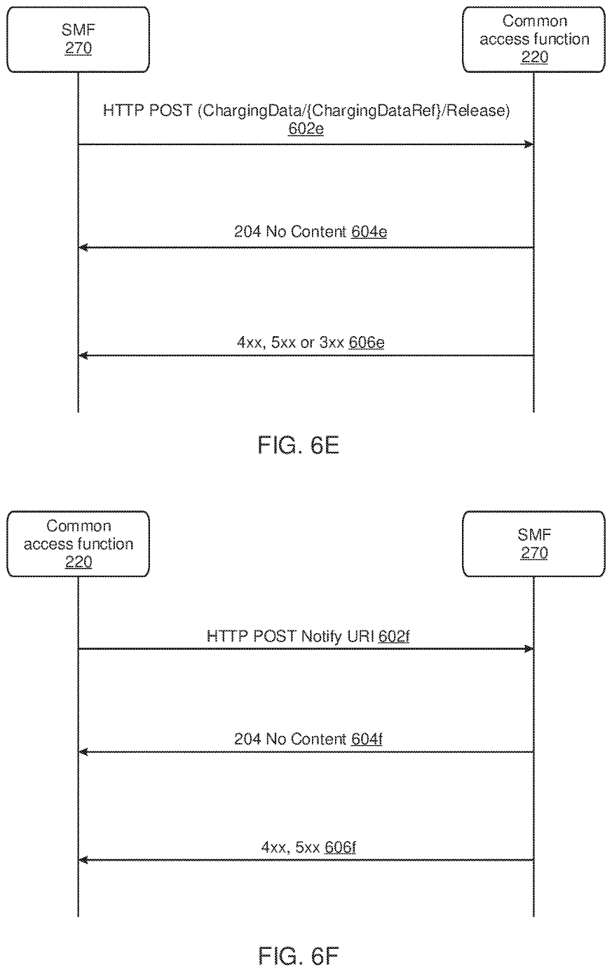

FIG. 8 is an example sequence diagram showing various signalling messages exchanged for charging of the UE belonging to public network and/or private network. In this example, it is considered that UE belongs to public network. Initially, PDU session(s) are in progress 1102. The SMF 270 transmits 1104 charging data request through Nchf to common access function 220. It should be noted that when the UE belongs to the NPN, the charging data request comprises public network identifier of NPN, DCS and network service identifier, to the common access function 220.

The common access function 220 determines 1106 a network rating function. The common access function determines the UE rating function 240a when the UE belongs to a public network. Upon determining the UE rating function 240a, the common access function 220 transmits 1108 a rating request 1108 to the UE rating function 240a. The UE rating function 240a transmits 1110 a rating response to the common access function 220. After receiving the rating response from the common access function 220, the common access function 220 transmits 1112 charging service request to the network charging function 260. Further, the common access function 220 receives 1114 charging service response from the network charging function 260. After receiving the charging service response, the common access function 220 transmits 1116 charging data response. In order to perform charging functionality, the network charging function opens 1118 charging data request.

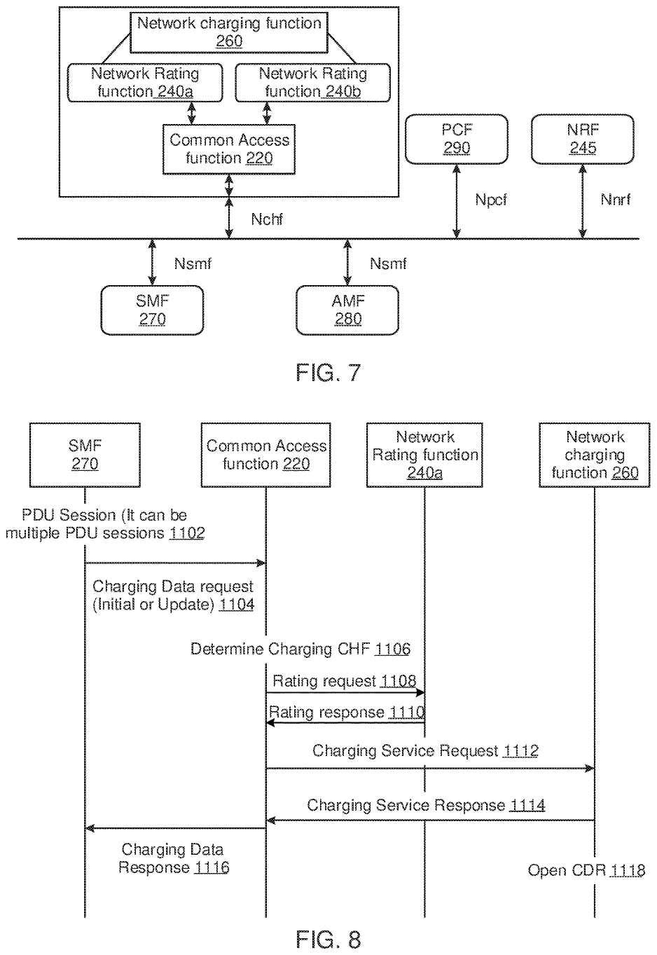

FIG. 9 is an example block diagram illustrating multiple non-public networks connected to the common access function and the network charging function. As depicted in the FIG. 9, multiple NPN networks can be connected to the common access function 220 and also multiple NPN networks can be connected to the network charging function 260. This integration is possible when there are N number of small private networks with high capacity common access function 220 that can serve multiple NPN networks.

In the above scenario, multiple NPN's are identified using PNI NPN having PLMN Id and private network ID. The common access function 220 acts as access charging function providing balance and Failover scenarios. The common access function 220 maintains status of each NPN network, accordingly routes the traffic. Thus, the proposed converged charging solution can be used in enterprise networks.

It should be noted that the common access function together with rating functions having common access enables serving multiple rating functions and for achieving converged charging.

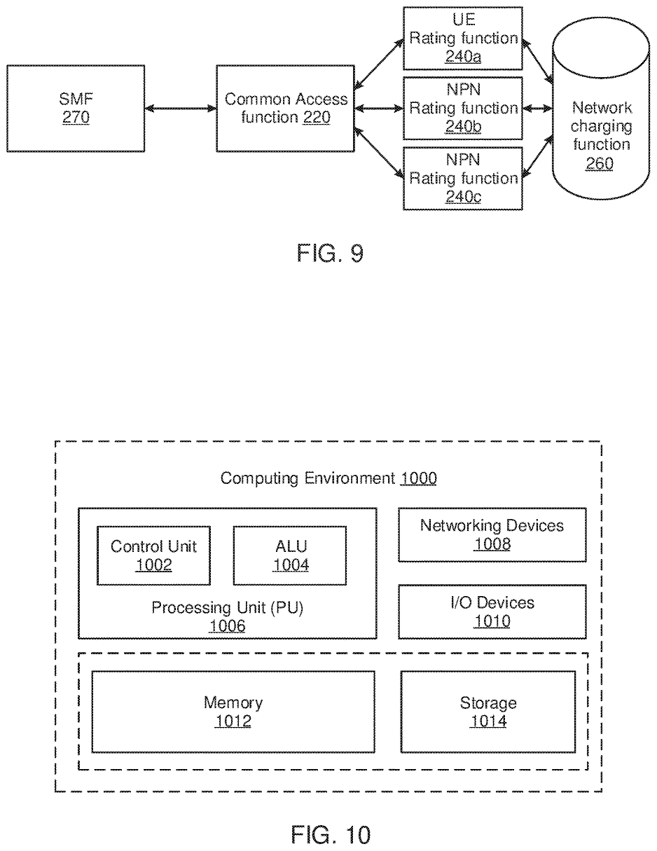

FIG. 10 illustrates an example computing environment 1000 implementing the converged charging system 200 and the method 300 as described in FIGS. 2 and 3. As depicted in FIG. 10, the computing environment 1000 comprises at least one data processing unit 1006 that is equipped with a control unit 1002 and an Arithmetic Logic Unit, ALU 1004, a memory 1012, a storage 1014, plurality of networking devices 1008 and a plurality Input output, I/O devices 1010. The data processing unit 1006 is responsible for processing the instructions of the algorithm. For example, the data processing unit 1006 is equivalent to the processing circuitry of a network node or network function. The data processing unit 1006 is capable of executing software instructions stored in memory 1012. The data processing unit 1006 receives commands from the control unit 1002 in order to perform its processing. Further, any logical and arithmetic operations involved in the execution of the instructions are computed with the help of the ALU 1004.

The data processing unit 1006 causes the network node obtaining the session logs associated with the plurality of network nodes in the communication network. Further, the data processing unit 1006 causes the extraction of session features for each session by evaluating the session logs associated with the plurality of network nodes. The data processing unit 1006 causes the determination of the access behaviours associated with each session based on the extracted session features. Further, the data processing unit 1006 causes the detection of anomalous access behaviours by analysing the determined access behaviours.

The overall computing environment 1000 can be composed of multiple homogeneous and/or heterogeneous cores, multiple CPUs of different kinds, special media and other accelerators. The data processing unit 1006 is responsible for processing the instructions of the algorithm. Further, the plurality of data processing units 1006 may be located on a single chip or over multiple chips.

The algorithm comprising of instructions and codes required for the implementation are stored in either the memory 1012 or the storage 1014 or both. At the time of execution, the instructions may be fetched from the corresponding memory 1012 and/or storage 1014, and executed by the data processing unit 1006.

In case of any hardware implementations various networking devices 1008 or external I/O devices 1010 may be connected to the computing environment to support the implementation through the networking devices 1008 and the I/O devices 1010.

The embodiments disclosed herein can be implemented through at least one software program running on at least one hardware device and performing network management functions to control the elements. The elements shown in FIG. 10 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1. A method for charging of a user equipment, UE belonging to at least one of a public network, PN, and a non-public network, NPN, for network delivered services, wherein a public network integrated non-public network, PNI-NPN, is implemented in a wireless network communication network, the method being performed by a network charging function in the PNI-NPN of the wireless communication network, the network charging function being configured for charging the UE for the network delivered services, the method comprising:
identifying whether the UE belongs to the PN or the NPN;
determining a network rating function for the UE based on the identification of the UE, wherein when the UE belongs to the PN, the network rating function is defined for a plurality of UEs belonging to the PN and wherein when the UE belongs to the NPN, one or more network rating functions are defined for a plurality of UEs belonging to the NPNs; and
initiating charging of the UE according to the determined network rating function for the UE.

2. The method according to claim 1, wherein the step of initiating charging of the UE according to the determined network rating function for the UE comprises:
obtaining information related to a network delivered service being requested by the UE;
determining a network rating function suitable for rendering the network delivered service for the UE;
receiving, from a session management function, a charging data request, the charging data request comprising network related parameters of the UE and
initiating charging of the UE for the network delivered service rendered to the UE according to the determined rating function using the network related parameters.

3. The method according to claim 1, wherein the step of identifying whether the UE belongs to a PN or a NPN comprises:
receiving, from a session management function, SMF, network related parameters of the UE; and
identifying whether the UE belongs to a PN or a NPN based on the network related parameters.

4. The method according to claim 2, wherein the network related parameters comprise one or more of:
a Mobile country code, MCC;
a Mobile Station International Subscriber Directory Number, MSISDN;
a public network identifier of NPN;
a Default credential server, DCS; and
a Network service identifier.

5. The method according to claim 2, wherein the step of receiving from a session management function, SMF, network related parameters of the UE comprises:
receiving a charging data request, CDR, from the SMF, wherein the CDR comprises the network related parameters of the UE.

6. The method according to claim 2, wherein the step of initiating charging of the UE for the network delivered service rendered to the UE according to the determined rating function using the network related parameters comprises:
storing the network related parameters received in the CDR;
receiving a charging service request;
transmitting a charging service response; and
initiating the charging of the UE.

7. A converged charging system for charging a user equipment, UE belonging to at least one of a public network, PN, and a non-public network, NPN, for network delivered services, wherein a public network integrated non-public network, PNI-NPN, is implemented in a wireless communication network the charging system comprises a common access function a network rating function belonging to the PN and one or more network rating functions belonging to the NPN and a network charging function wherein the charging system being configured to:
identify whether the UE belongs to the PN or the NPN;
determine a network rating function for the UE based on the identification of the UE, wherein when the UE belongs to the PN, the network rating function is defined for a plurality of UEs a belonging to the PN and wherein when the UE belongs to the NPN, one or more network rating functions are defined for a plurality of UEs belonging to the NPNs; and
initiate charging of the UE according to the determined network rating function for the UE.

8. The converged charging system according to claim 7, wherein the charging function is configured to initiate charging of the UE according to the determined network rating function for the UE by:
obtaining information related to a network delivered service being requested by the UE
determining a network rating function suitable for rendering the network delivered service for the UE;
receiving, from a session management function, a charging data request, the charging data request comprising network related parameters of the UE; and
initiating charging of the UE for the network delivered service rendered to the UE according to the determined rating function using the network related parameters.

9. The converged charging system according to claim 7, wherein the common access function is configured to identify whether the UE belongs to the PN or the NPN by:
receiving, from a session management function, network related parameters of the UE
identifying whether the UE belongs to a PN or a NPN based on the network related parameters.

10. The converged charging system according to claim 8, wherein the network related parameters comprise one or more of:
Mobile country code, MCC;
Mobile Station International Subscriber Directory Number, MSISDN;
public network identifier of NPN;
Default credential server, DCS; and
Network service identifier.

11. The converged charging system according to claim 8, wherein the network charging function is configured to receive the network related parameters of the UE from a session management function, SMF, by:
receiving a charging data request, CDR, from the SMF, wherein the CDR comprises the network related parameters of the UE.

12. The converged charging system according to claim 8, wherein the network charging function is configured to initiate charging of the UE for the network delivered service rendered to the UE using the network related parameters by:
storing the network related parameters received in the CDR;
receiving a charging service request;
transmitting a charging service response; and
initiating the charging of the UE

13. A computer program product comprising a non-transitory computer readable medium, having thereon a computer program comprising program instructions, the computer program is loadable into a data processing unit and configured to cause execution of the method according to claim 1, when the computer program is run by the data processing unit.
